(19) United States
(12) Patent Application Publication
(10) Pub. No.: US 2024/0171056 A1
(43) Pub. Date: May 23, 2024

(54) ELECTRIC CIRCULATORY LEVERAGE DRIVE METHOD AND APPARATUS

(71) Applicant: Airborne Motors, LLC, The Woodlands, TX (US)

(72) Inventors: Jesse Antoine Marcel, Veradale, WA (US); Jeffrey Scott Chimenti, The Woodlands, TX (US)

(21) Appl. No.: 18/520,469

(22) Filed: Nov. 27, 2023

Related U.S. Application Data
(63) Continuation of application No. 16/824,200, filed on Mar. 19, 2020, now abandoned.
(60) Provisional application No. 62/820,840, filed on Mar. 19, 2019.

(51) Int. Cl. H02K 53/00; H02K 3/22; H02K 7/10; H02K 11/00; H02K 11/30; H02K 21/14

(52) U.S. Cl. CPC H02K 53/00; H02K 3/22; H02K 7/1004; H02K 11/0094; H02K 11/30; H02K 21/14

(57) ABSTRACT

An electric circulatory leverage drive method and apparatus to replace industrial motors in a variety of applications. The invention includes a hubless magnetic gyroscope that creates leveraged rotational torque/horsepower from its perimeter, that is propelled by a circulatory field double helix coil assembly located proximate to the magnetic gyroscope, and that produce both phasing electromagnetic energy in one of its two strands while the second strand returns the unused portion of the electromagnetic fields to the power source as electricity to increase overall efficiency. Connected to the hubless gyroscope is a means to transfer rotation from the gyroscope to the end use. The present invention is capable of replacing conventional electric motors with a more efficient, compact and lightweight alternative.

### PRIORITY CLAIM

This application is a continuation of U.S. patent application Ser. No. 16/824,200 filed Mar. 19, 2020; which claims the benefit of priority from U.S. Provisional Patent Application No. 62/820,840 filed Mar. 19, 2019, the contents of which is incorporated herein by reference in its entirety.

### FIELD OF THE INVENTION

This invention relates generally to electric motors. More Specifically, the invention comprises an electric drive system that replaces conventional motors with a more efficient, compact and lightweight alternative.

### BACKGROUND OF THE INVENTION

There are many known electric motors used in a wide range of industries. Most of these rotate an armature in a central hub using phasing magnetic fields acting upon permanent magnets.

The size and complexity of these motors is proportional to their output; the higher the horsepower, the greater the weight, size and complexity. The present invention provides an alternative to current motor design in an efficient, lightweight, powerful and simple to manufacture method and apparatus.

### SUMMARY OF THE INVENTION

The present invention comprises an electric leverage drive method and apparatus for any industry that utilizes electric motors for power. The invention is configured to be in the position customarily occupied by the motor it replaces as well as being powered from the same source.

The invention includes a hubless magnetic gyroscope that is propelled by a ring that contains circulatory field coils that produce phasing electromagnetic energy located proximate to the magnetic gyroscope. The electrically conductive circulatory field coil system returns the unused portion of the electromagnetic fields back to the power source as electricity to increase overall efficiency. The induction coil creates an electromagnetic field and functions as an artery by delivering energy to the motor. The collection coil collects unused electromagnetic energy and functions as a vein by returning electric energy to the battery.

Connected to the hubless gyroscope is a means to transfer rotation from the gyroscope to the end use.

Control features are preferably provided by microprocessors that control each individual electromagnetic field coil, one controller per coil, allowing for timing changes based on the industry. For example, changes in torque and horsepower are created by altering the electric leverage drive's timing in virtually infinite ways through its fully digital control means.

### BRIEF DESCRIPTION OF THE DRAWINGS

Preferred and alternative examples of the present invention are described in detail below with reference to the following drawings:

FIG. 1 is a perspective view, showing the present invention with transmission means.

FIG. 2 is a cross-section view of the present invention.

FIG. 3 is a front view, showing a circulatory field coil section.

FIG. 4 is a front view, showing a circulatory field coil wrapped around a stator tooth.

FIG. 5 is a schematic view, showing how the circulatory field coils recirculates energy back to the batteries.

### DETAILED DESCRIPTION OF THE PREFERRED EMBODIMENT

The terminology used herein is for describing particular embodiments only and is not intended to be limiting of the invention. As used herein, the term “and/or” includes any and all combinations of one or more of the associated listed items. As used herein, the singular forms “a,” “an” and “the” are intended to include the plural forms as well as the singular forms, unless the context clearly indicates otherwise. It will be further understood that the terms “comprises” and/or “comprising” when used in this specification, specify the presence of stated features, steps operations, elements, and/or components, but do not preclude the presence of addition of one or more other features, steps, operations, elements, components, and/or groups thereof.

Unless otherwise defined, all terms (including technical and scientific terms) used herein have the same meaning as commonly understood by one having ordinary skill in the art to which the invention belongs. It will be further understood that terms, such as those defined in commonly used dictionaries, should be interpreted as having a meaning that is consistent with their meaning in the one context of the relevant art and the present disclosure and will not be interpreted in an idealized or overly formal sense unless expressly so defined herein.

In describing the invention, it will be understood that several techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combination are entirely within the scope of the invention and the claims

New electric circulatory leverage drive method and apparatus for creating an alternative to current motor design in a lightweight, powerful and simple to manufacture method and apparatus is discussed herein. In the following description, for the purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

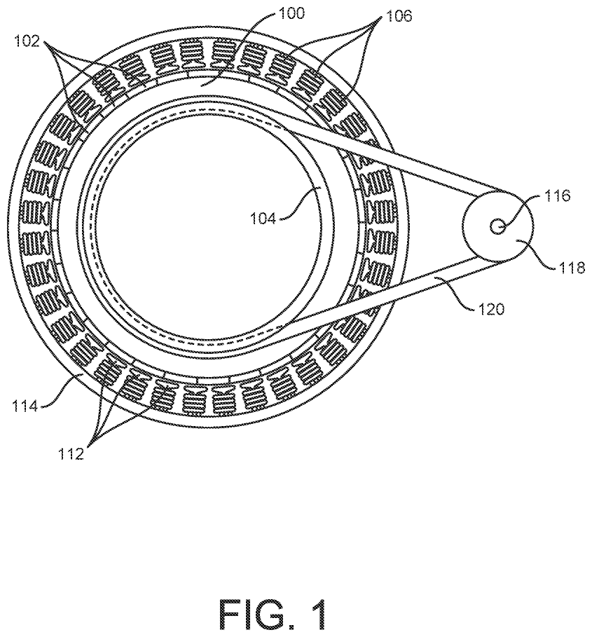

The present invention will now be described by referencing the appended figures representing preferred embodiments. FIG. 1 depicts a front view of the elements that may comprise an electric circulatory leverage drive method and apparatus device (the “device”) according to various embodiments of the present invention. The layout of the invention results in two methods that create efficiency: a first through leverage because the drive creates torque/horsepower from the outside rather than the center multiplying the rotational force; and a second through a circulatory system that captures excess magnetic fields created by DNA-shaped double helix field coils and sends the energy back to the batteries. In preferred embodiments, the general assembly FIG. 1 contains each of the elements of the device configured with at least one central gyroscope flywheel 100 which may be made of lightweight composite materials, aluminum, or another suitable material and is configured to accept a plurality of magnets 102 along the gyroscopes' exterior perimeter. Vertical protrusions, not shown, separate the magnets when necessary to split the surface area of the gyroscopes' perimeter equally. In an alternate embodiment the gyroscope flywheel, all or in part, is composed of magnetic field producing elements, which may be made of composite fabrics, neodymium particles copper or another suitable material embedded into its composite structure. In a preferred embodiment, the gyroscope flywheel is supported by a system of bearings, not shown, that allow free rotation. In an alternate embodiment, the gyroscope flywheel integrates a central hub that locates bearings for rotation.

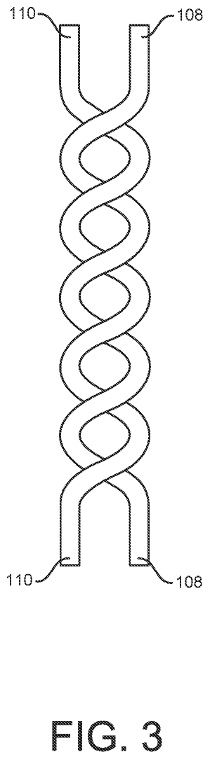

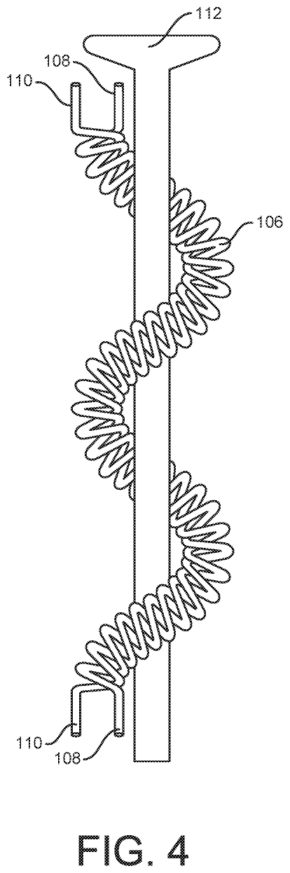

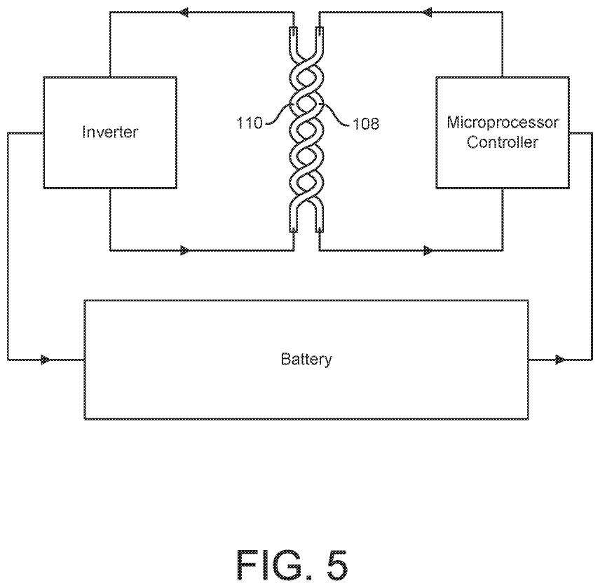

Proximate to the gyroscope flywheel is stator 114, which may be made of lightweight composite materials, iron, or another suitable material. The teeth 112 of the stator 114 shown in FIGS. 1 and 4 are individually wrapped by circulatory field coils 106 shown in FIGS. 1, 2 and 4, which may be made of copper, or another suitable material. The induction side of the circulatory field coil assembly 108 shown in FIGS. 3-5 create multi-phase electromagnetic fields that cause rotation of the flywheel governed by individual motor controllers, one controller per circulatory field coil.

In an alternate embodiment, multiple induction field coils may be controlled by a single motor controller. In yet an alternate embodiment, the bodywork or shell surrounding the magnetic gyroscope integrates the circulatory field coils in its skin. The shell is manufactured with a network of electrically conductive materials integrated into its composite matrix inside of or along the shell's inner surfaces.

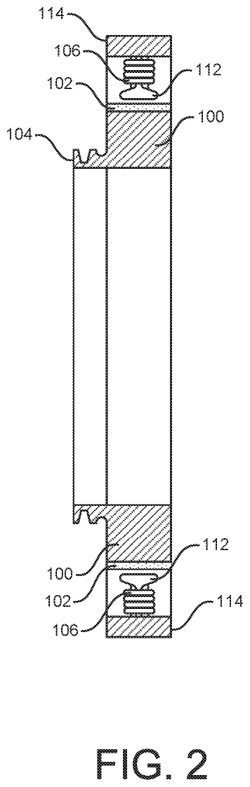

FIG. 2 depicts a cross-section view of the elements that may comprise an electric circulatory leverage drive method and apparatus device according to various embodiments of the present invention. In preferred embodiments, FIG. 2 depicts a cross section of the current invention that locates the gyroscope flywheel 100 and permanent magnets 102. The flywheel integrates output pulley 104 that locates belt 120 shown in FIG. 1, which transfers rotational energy to the end use represented by receiving pulley 118 that rotates axle 116. The belt can be replaced by gears, driveshaft, or any means to connect the motor. The transfer means can be connected to the motor at any point between its center and perimeter with the greatest leverage effect taking place at or near the perimeter of the flywheel.

FIG. 3 depicts a segment of a field coil that is constructed from two strands of copper twisted together in a double helix coil, or materials with similar properties. Strand 108, the induction coil, receives energy to create magnetic fields and strand 110, collection coil, circulates unused magnetic energy that is converted back into electricity, to the batteries. FIG. 4 depicts the coiled double helix field coil strands wrapped around one of the stator teeth 112, also shown in FIGS. 1-2. In an alternate embodiment, the induction and collection coils can be made from differing conductive materials, for example the inductive coil may be made from copper while the collection coil may be made from aluminum.

FIG. 4 depicts a schematic of the present invention's circulatory system. Energy from the battery is sent to the circulatory field coil's induction side 108 through a microprocessor controller while excess energy is converted into electricity and is sent back to the battery through an inverter. In an alternate embodiment, a single strand conventional field coil may be used in place of the circulatory collection coil.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. An energy regenerative motor comprising:
a controller for ingoing electrical energy;
an inverter for outgoing electrical energy;
a battery configured to send and receive electrical energy;
a stator used to align interwoven field coils;
a plurality of permanent magnets;
an armature that aligns permanent magnets to create rotation; and
a plurality of interwoven electrically conductive field coils that propel the armature while collecting errant magnetic fields.

2. The energy regenerative motor of claim 1, further comprising a pulley mechanism to connect rotational energy to desired device.

3. The energy regenerative motor of claim 1, wherein the plurality of interwoven field coils are configured to create a motor that is its own generator.

4. The energy regenerative motor of claim 1, further comprising a leveraged drive that creates a circulatory system by operating as a generator and motor at the same time.

5. The energy regenerative motor of claim 1, further comprising a leveraged hubless drive configured to create high torque with magnetic energy created along its perimeter.
